(19) United States
(12) Patent Application Publication
(10) Pub. No.: US 2010/0073713 A1
(43) Pub. Date: Mar. 25, 2010

(54) APPARATUS, METHOD AND SYSTEM TO TRANSFER DOCUMENT

(75) Inventor: Kyoung-youl CHAE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/485,386

(22) Filed: Jun. 16, 2009

(30) Foreign Application Priority Data
Sep. 22, 2008 (KR) 2008-0092737

(51) Int. Cl. G06F 3/12; G06F 17/30; G06F 15/16

(52) U.S. Cl. 358/1.15; 707/E17.008; 707/E17.032; 709/204

(57) ABSTRACT

A document transfer method, document transfer apparatus and document transfer system. The document transfer method includes transferring a document and metadata required to request an additional transfer of the document from a sending device to a receiving device, editing the transferred metadata to request an additional transfer of the document, storing the edited metadata in the receiving device, and additionally transferring the document based on the stored metadata by the sending device.

### CROSS-REFERENCE TO RELATED APPLICATIONS

This application claims priority under 35 U.S.C. §119 (a) from Korean Patent Application No. 10-2008-0092737, filed on Sep. 22, 2008, in the Korean Intellectual Property Office, the disclosure of which is incorporated herein by reference in its entirety.

### BACKGROUND

1. Field of the Invention

The present general inventive concept relates to an apparatus, method and system to transfer a document. More particularly, the present general inventive concept relates to an apparatus, method and system by which a receiving device is able to request that a sending device additionally transfer a document.

2. Description of the Related Art

As a result of recent developments in communication technology, a sender may transmit an e-mail message using an image forming apparatus, or may store a file in a file transfer protocol (FTP) server. For example, if a sender logs onto an image forming apparatus, and selects a receiver to which a scanned file is to be transferred, the image forming apparatus may transfer the scanned file to the selected receiver.

If the document transfer method described above is used, the sender can transfer the scanned file to a plurality of receivers if necessary. However, if the receiver forwards the received file to another person or stores the received file in another format, the receiver needs to transmit a request to the sender by e-mail, telephone or other means. Accordingly, if a received file needs to be transferred to another destination, a user may be required to send a request, which causes inconvenience to the user.

### SUMMARY

The present general inventive concept provides an apparatus, method and system to transfer a document, in which a request may be automatically sent to a sending device, instead of a sender, to additionally transfer a document.

Additional features and utilities of the present general inventive concept will be set forth in part in the description which follows and, in part, will be obvious from the description, or may be learned by practice of the general inventive concept.

Exemplary embodiments of the present general inventive concept may be achieved by providing a document transfer method including transferring a document and metadata required to manage the document from a sending device to a receiving device, editing the transferred metadata, storing the edited metadata, and additionally transferring the document from the sending device based on the stored metadata.

The editing of the transferred metadata may include displaying the transferred metadata, and adding at least one destination and at least one transfer mode to the displayed metadata, to edit the metadata.

The document transfer method may further include determining whether the transferred metadata is edited, and adding the edited metadata to a queue of the sending device if it is determined that the transferred metadata is edited.

The additionally transferring of the document may include checking a destination entered by a user of the receiving device from the edited metadata added to the queue, and additionally transferring the document to the checked destination.

The metadata transferred to the receiving device may include an expiration time prior to which the document can be additionally transferred.

The document transfer method may further include accessing the receiving device at a regular interval set for the transferred metadata and determining whether the edited metadata is stored.

The document transfer method may further include displaying a result of whether or not the document was additionally transferred on at least one of the sending device and the receiving device.

The sending device may be one of at least one image forming apparatus and a server to manage the document. The receiving device and the destination may be at least one of an image forming apparatus, a simple mail transfer protocol (SMTP) server, a file transfer protocol (FTP) server, a public folder and a personal terminal to receive the document.

Exemplary embodiments of the present general inventive concept may also be achieved by providing a document transfer apparatus including a storage unit to store metadata required to manage a document, a communication unit to transfer the document and the stored metadata to a receiving device, and to poll the transferred metadata to determine if the transferred metadata is edited, and a control unit to control the communication unit to additionally transfer the document based on the edited metadata.

A user of the receiving device may add at least one destination and at least one transfer mode to the transferred metadata, to edit the transferred metadata.

If it is determined that the transferred metadata is edited, the control unit may load the edited metadata stored in the receiving device and add the loaded metadata to a queue.

The control unit may check a destination entered by the user of the receiving device from the edited metadata added to the queue, and control the communication unit to additionally transfer the document to the checked destination.

The document transfer apparatus may further include a display unit to display a menu to select a transfer of the metadata, and a user input unit to select a transfer of the metadata through the displayed menu, and to set an expiration time prior to which the document can be additionally transferred. The control unit may access the receiving device before the set expiration time.

The metadata transferred to the receiving device may include the set expiration time.

The document transfer apparatus may further include a display unit to display a menu to select a transfer of the metadata, and a user input unit to select a transfer of the metadata through the displayed menu, and to set a polling interval to access the receiving device through the displayed menu. The control unit may access the receiving device at the set polling interval to determine whether the metadata is edited.

The sending device may be one of at least one image forming apparatus and a server to manage the document. The receiving device and the destination may be at least one of an image forming apparatus, a simple mail transfer protocol (SMTP) server, a file transfer protocol (FTP) server, a public folder and a personal terminal to receive the document.

A result of whether or not the document was additionally transferred may be displayed on at least one of the sending device and the receiving device.

Exemplary embodiments of the present general inventive concept may also be achieved by providing a document transfer system including a sending device to transfer a document and metadata required to request an additional transfer of the document, and at least one receiving device to receive the document and the metadata and to store the metadata edited to additionally transfer the document. The sending device may additionally transfer the document based on the edited metadata.

The document transfer system may further include a user terminal to access the receiving device, display the transferred metadata, enter at least one destination in the displayed metadata, edit the metadata, and control the edited metadata to be stored in the receiving device.

Exemplary embodiments of the present general inventive concept may also be achieved by providing a method of transferring a document in a receiving device, the method including receiving a document and metadata associated with the document from a sending device, and editing the metadata and transmitting the edited metadata to the sending device to request the sending device to transfer the document to a second receiving device according to the edited metadata.

Editing the metadata may include adding a destination for the second receiving device.

The metadata may include an expiration time, where the document can not be transferred to the second receiving device after the expiration time.

The metadata may include a polling interval, and the method may further include polling the metadata at the polling interval to determine if it has been edited.

The editing may be performed at a receiving device which receives the document and the metadata.

The method may further include if the metadata is edited, transferring the edited metadata to the sending device and transferring the document to the second receiving device according to the edited metadata.

Exemplary embodiments of the present general inventive concept may also be achieved by providing an apparatus for transferring a document, including a communication unit to receive a document and metadata associated with the document from a sending device, and a user input unit to edit the metadata, the edited metadata to be transmitted to the sending device to request the sending device to transfer the document to a second receiving device according to the edited metadata.

The metadata may include an expiration time, where the document can not be transferred to the second receiving device after the expiration time.

The metadata may include a polling interval, and the document receiving apparatus may indicate to the sending device at the polling interval whether the control metadata has been edited.

The edited metadata may include a destination for the second receiving device.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 illustrates a document transfer system according to exemplary embodiments of the present general inventive concept;

FIG. 2 illustrates a block diagram of an image forming apparatus used as a document transfer apparatus according to exemplary embodiments of the present general inventive concept;

FIGS. 3A to 3D are views provided to explain a method of setting initial metadata;

FIG. 4 exemplarily illustrates a document and initial metadata transferred to a receiving device;

FIGS. 5A and 5B exemplarily illustrate initial metadata provided to a user of a receiving device, and metadata edited by the user, respectively;

FIGS. 6A and 6B exemplarily illustrate information on initial metadata and information on edited metadata, respectively;

FIGS. 7A to 7D exemplarily illustrate user interfaces (UIs) showing initial metadata provided to a user of a receiving device, and metadata edited by a user;

FIG. 8 exemplarily illustrates initial metadata provided to a user of a receiving device when the receiving device is an SMTP server;

FIG. 9 illustrates a block diagram of a document management apparatus used as a document transfer apparatus according to exemplary embodiments of the present general inventive concept;

FIG. 10 is a flowchart illustrating a document transfer method according to exemplary embodiments of the present general inventive concept; and

FIG. 11 is a flowchart illustrating a method by which a receiving device requests additional transfer of a document according to exemplary embodiments of the present general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

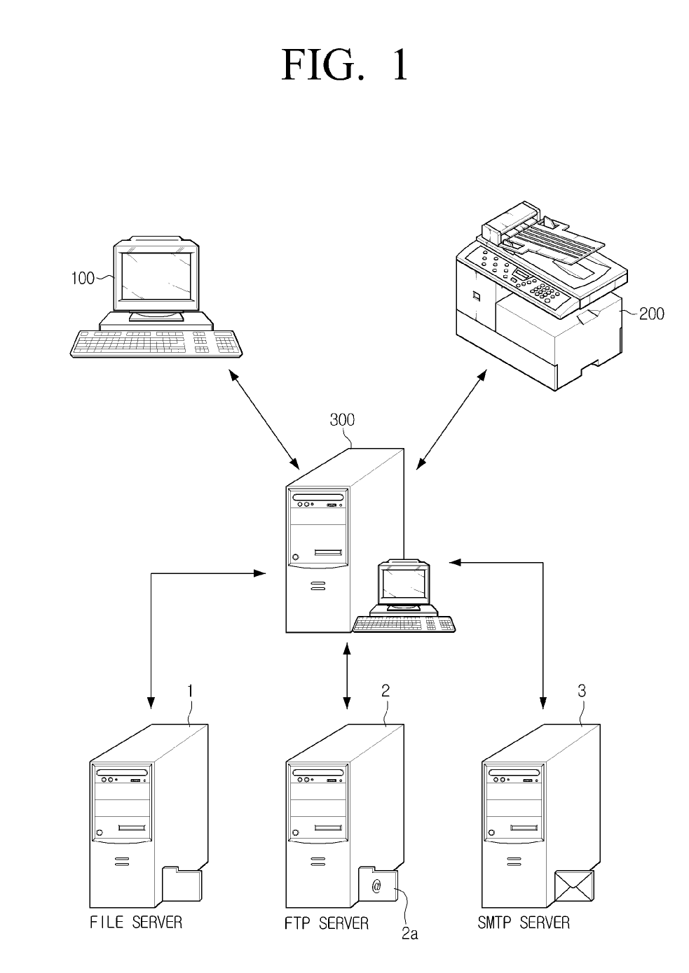

FIG. 1 illustrates a document transfer system according to an exemplary embodiment of the present general inventive concept.

The document transfer system illustrated in FIG. 1 includes a user terminal 100, an image forming apparatus 200, a document management apparatus 300, a file server 1, a file transfer protocol (FTP) server 2 and a simple mail transfer protocol (SMTP) server 3 which are communicably connected through a wire or wireless communication network. The file server 1, FTP server 2 and SMTP server 3 are used to store data. The user terminal 100, the image forming apparatus 200, the file server 1, the FTP server 2 and/or the SMTP server 3 may have terminals connected to terminals on the document management apparatus 300 by a communication line. Terminals on the user terminal 100, the image forming apparatus 200, the file server 1, the FTP server 2, the SMTP server 3, and the document management apparatus 300 may also be connected to a wired network or to a bus to allow communication. Furthermore, one or more of the user terminal 100, the image forming apparatus 200, the document management apparatus 300, and the servers 1-3 may be connected by its respective terminals to a wireless device to permit communication in a wireless network environment.

The user terminal 100 may include, for example, a personal computer (PC), a personal digital assistant (PDA), a laptop, a mobile device, such as a cell phone, or another similar computing platform. The image forming apparatus 200 may include an apparatus capable of forming an image, for example a multifunctional peripheral (MFP), a printer, a facsimile machine, a scanner or a copier. The document transfer system illustrated in FIG. 1 may include a plurality of user terminals 100, a plurality of image forming apparatuses 200, a plurality of file servers 1, a plurality of FTP servers 2 and a plurality of SMTP servers 3. Each may be connected and may communicate over wires or wirelessly, as described above.

The image forming apparatus 200 can receive workforms written by a user from the document management apparatus 300 and can store the received workforms in a memory. The memory may be internal to the image forming apparatus 200, and may also be external to the image forming apparatus 200 and communicably connected thereto. The memory may also be an external memory, using, for example, a universal serial bus (USB) connection. The image forming apparatus 200 may be operated according to a workform selected from stored workforms. The image forming apparatus 200 may function as a sending device to transfer a document corresponding to a selected workform to a receiving device, or as a receiving device to receive a document from the document management apparatus 300 or other image forming apparatuses.

The document management apparatus 300 can store logon information (for example, identifications (IDs) and passwords) of pre-registered users, and a plurality of workforms can be set for each of the users. Additionally, the document management apparatus 300 can be equipped with a workform management solution (for example, an application program) to write workforms. The document management apparatus 300 may be a server managed by an administrator, or may be a computer usable by general users. The document management apparatus 300 may function as a sending device to transfer a document corresponding to a workform to a receiving device. Accordingly, the image forming apparatus 200 and the document management apparatus 300 may act as sending devices, namely document transfer apparatuses.

A workform can include all types of information required for the image forming apparatus 200 to perform various jobs. For example, the workform may include a plurality of pieces of information regarding a device to perform a job, an order for processing the job, a plurality of job conditions or a location at which a job execution result is to be stored. If stored workforms are used, a user may select one of a plurality of pre-defined workforms so that a job can be performed automatically without needing to set job conditions whenever the image forming apparatus 200 is used. If a solution, such as an application, related to writing of workforms is installed on the image forming apparatus 200, a user may write a workform using the image forming apparatus 200.

A user may write workforms and request execution of the written workforms using the user terminal 100, the document management apparatus 300 or the image forming apparatus 200. For example, if a user logs onto the document management apparatus 300 through the user terminal 100, the document management apparatus 300 may send a user interface screen provided by the solution to the user terminal 100. The user terminal 100 may also have an application program installed which permits a user to write workforms on the user terminal 100 and to transmit information corresponding to the workform to the document management apparatus 300. Accordingly, the user may write workforms using the user terminal 100, and the written workforms may be transmitted to the document management apparatus 300 and stored in the document management apparatus 300. The document management apparatus 300 may write workforms in a programming language, such as extensible Markup Language (XML), in response to a user request.

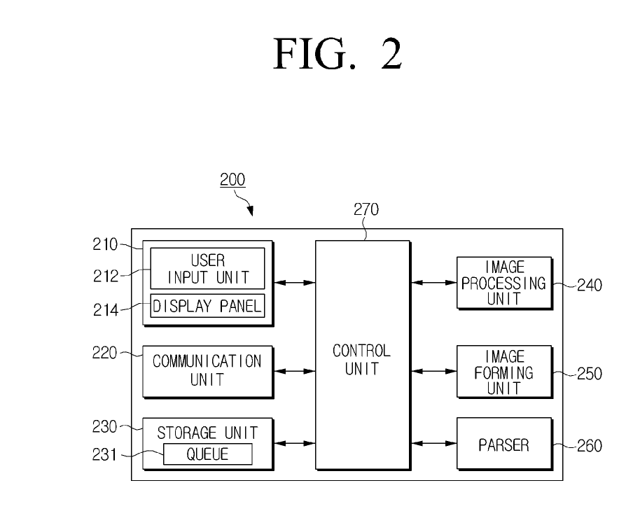

FIG. 2 illustrates a block diagram of the image forming apparatus 200 according to an exemplary embodiment of the present general inventive concept.

In FIG. 2, the image forming apparatus 200 may function as a document transfer apparatus, namely a sending device, and includes an operating panel 210, a communication unit 220, a storage unit 230, an image processing unit 240, an image forming unit 250, a parser 260 and a control unit 270.

The operating panel 210 includes a user input unit 212 and a display panel 214. The user input unit 212 may include, for example, a plurality of function keys or a touch screen to receive an input from a user. The user input unit 212 can receive a user command input by a user and can send a request in response to the received user command to the control unit 270. If a document corresponding to a workform is transferred to a receiving device, the user input unit 212 can be used to select initial metadata to be transferred along with the document, through a metadata setting menu displayed on the display panel 214, and can set a polling interval and an expiration time of the selected initial metadata such that the control unit 270 periodically accesses the receiving device before the expiration time. The receiving device may be at least one of another image forming apparatus (not illustrated), the user terminal 100, the file server 1, the FTP server 2 and the SMTP server 3.

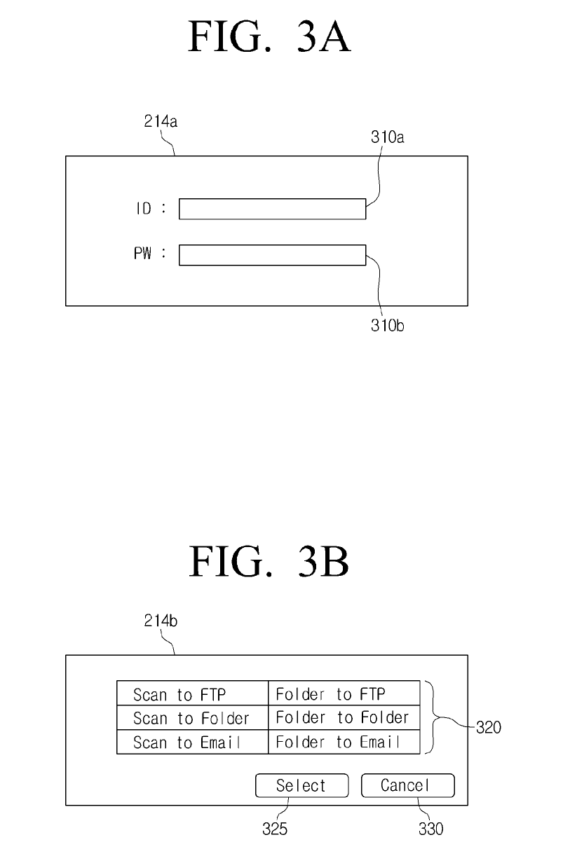

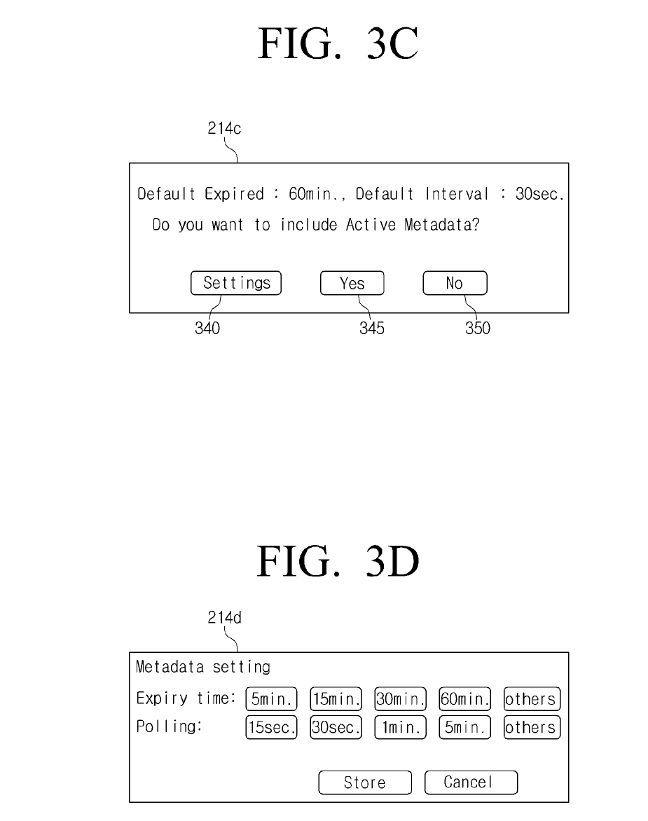

The display panel 214 is controlled by the control unit 270 to display information on the state of the image forming apparatus 200, and to display the workforms received from the document management apparatus 300 and menus illustrated in FIGS. 3A to 3D.

The communication unit 220 may be communicably connected to the user terminal 100, another image forming apparatus (not illustrated), the document management apparatus 300, the file server 1, the FTP server 2 and/or the SMTP server 3 via a communication network (not illustrated). Metadata may be generated from the control unit 270 and can be sent to a receiving device to permit a user of the receiving device to request an additional transfer of a document. The communication unit 220 can output the workform received from the document management apparatus 300 to the image processing unit 240, can periodically access the receiving device (for example, to determine if initial metadata has been edited), and can load edited metadata corresponding to a document from the receiving device to process a request to additionally transfer the document. The initial metadata may be edited at a receiving device to create edited metadata using an original editing application, or other applications designed only for editing.

The storage unit 230 can store various programs required to operate the image forming apparatus 200, workforms, documents transferred to the receiving device, or initial metadata. The storage unit 230 can include a queue 231 to which initial metadata, of which the expiration time or polling interval can be set through the metadata setting menu, and metadata edited by a receiver are added.

If only a single piece of metadata is edited, the edited metadata may be set so as not to be added to the queue 231. In more detail, the control unit 270 may check a destination described in the edited metadata and additionally transfer a document to the destination. Alternatively, if a plurality of pieces of metadata are edited, the plurality of pieces of edited metadata may be set to be added to the queue 231, so the control unit 270 may additionally transfer documents in sequence.

Metadata is required when a user of a receiving device (hereinafter referred to as a receiver) for receiving documents from a sending device requests that the sending device additionally transfer the received documents to another destination. Initial metadata may be selected by a user of the sending device (hereinafter referred to as a sender) when the sender is to transfer documents, and may include one or more items through which the destination is able to be input.

When the sender (for example, using image forming apparatus 200) desires to transfer stored initial metadata to a receiving device (such as, for example, the user terminal 100, the file server 1, the FTP server 2, the SMTP server 3, or another image forming apparatus), the sender can set the polling interval required for the control unit 270 to access the receiving device and check whether the initial metadata is edited, and the expiration time prior to which the receiving device is able to request an additional transfer of the document. Initial metadata containing a variety of information may be added to the queue 231, for example the polling interval and expiration time which are set when a document is transferred first to the receiving device, an ID for the transferred document, and the time at which the initial metadata is added to the queue 231.

If the sender transfers the document but does not transfer metadata to the receiving device, it is impossible for the receiver to use the metadata to request an additional transfer of the document. Metadata settings will be described in detail with reference to FIG. 3D.

If the receiver writes metadata to request an additional transfer of the document, that is, if the receiver edits the metadata by entering a destination in the metadata, the edited metadata can be stored in the receiving device in which the initial metadata is stored. For example, if the receiving device is a directory 2a on the FTP server 2, the initial metadata and edited metadata may be stored in the directory 2a. If the set expiration time of the initial metadata is reached, it is impossible to additionally request a transfer of a corresponding document, and the initial metadata may be deleted from the queue 231 and from the receiving device.

The image processing unit 240 can process menus 214a and 214b required to select a workform to be displayed on the display panel 214, as illustrated in FIGS. 3A and 3B, and can also process metadata setting menus 214c and 214d to be displayed on the display panel 214, as illustrated in FIGS. 3C and 3D.

The image forming unit 250 can generate image data and can form an image. For example, if the image forming unit 250 includes a scanner (not illustrated), a print engine (not illustrated) and a modem (not illustrated), the image forming unit 250 may scan a document or print the scanned document on paper, or perform copying or fax data transmission.

The parser 260 can parse the edited metadata, if the edited metadata stored in the receiving device is loaded by the communication unit 220.

The control unit 270 controls the overall operations of the image forming apparatus 200 according to control programs stored in the image forming apparatus 200. In more detail, if a user presses a workform button of the user input unit 212 (which can be a physical button or a virtual button, such as on a touch screen), the control unit 270 enters a workform mode, and can control the communication unit 220 to try to access the document management apparatus 300. After login, if the user selects a desired workform using the user input unit 212 and decides to transfer metadata, the control unit 270 can control the communication unit 220 to transfer to the receiving device a document and initial metadata corresponding to the selected workform.

In this situation, the control unit 270 may notify the receiver that the document is transferred, using available means such as e-mail, text messaging or telephone. Therefore, it is possible for the receiver to request the image forming apparatus 200 to additionally transfer a required document to another destination before the expiration time.

The control unit 270 can control the initial metadata transferred to the receiving device to be stored in the queue 231. The stored initial metadata contains its expiration time and polling interval. Accordingly, the control unit 270 can determine whether the initial metadata is edited, while monitoring a directory of the receiving device in which the initial metadata is stored at the set polling interval until the expiration time.

In more detail, the control unit 270 can access the receiving device and can compare the initial metadata to other metadata. If the recent modified date and the size of the initial metadata differ, the control unit 270 can determine that the initial metadata has been edited, and can determine that a document is requested to be additionally transferred. Additionally, the control unit 270 can load the edited metadata, can add the loaded metadata to the queue 231, and can control the communication unit 220 so that the document is additionally transferred to a destination entered in the metadata added to the queue 231.

Hereinafter, a process by which a user (namely, a sender) of the image forming apparatus 200 transfers a document and metadata to a receiving device will be described with reference to FIGS. 3A to 3D.

If a user enters the workform mode by pressing a workform button of the user input unit 212, a login menu 214a having one or more sections 310a and 310b to allow a user to enter, for example, an identification (ID) and password (PW), is displayed on the display panel 214, as illustrated in FIG. 3A. If the user logs onto the document management apparatus 300 by inputting his or her ID and password into the login menu 214a, a workform list 214b mapped with 320 and stored by the user can be displayed on the display panel 214, as illustrated in FIG. 3B. Subsequently, if the user selects a desired workform from the workform list 214b using the user input unit 212, a message asking whether to transfer metadata along with a document corresponding to the selected workform can be displayed on the display panel 214, as illustrated in FIG. 3C. As illustrated in FIG. 3B, a “select” button 325, to confirm a selection, and a “cancel” button 330, to cancel a selection, may be included. A user may make a selection, for example, by touching a desired workform in the workform list 214b if the input unit 212 is implemented as a touch screen.

If the user selects ‘Yes’ 345 using the user input unit 212 in response to the message in a menu 214c displayed on the display panel 214 as illustrated in FIG. 3C, metadata having the expiration time and polling interval set to default values may be transferred along with the document to the receiving device, and may then be added to the queue 231.

Alternatively, if the user selects ‘Settings’ 340 using the user input unit 212 in response to the message displayed as illustrated in FIG. 3C, a metadata setting menu 214d to set configuration of the metadata may be displayed on the display panel 214, as illustrated in FIG. 3D. The metadata setting menu of FIG. 3D enables the sender to set the expiration time and polling interval of the metadata. The set expiration time and polling interval of the metadata are contained in the initial metadata. The initial metadata can be mapped to information to identify the transferred document, for example, the JobLog ID of the document corresponding to the workform selected from the workform list 320 of FIG. 3B, and the mapped metadata can be stored in the queue 231.

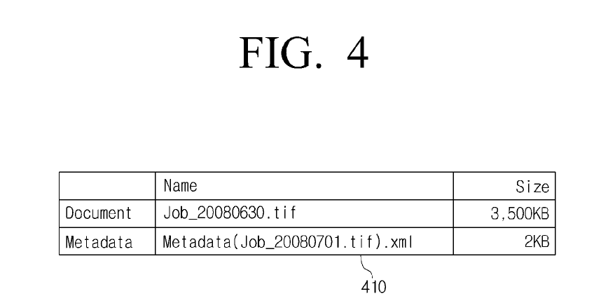

Accordingly, when the sender sends the document corresponding to the selected workform to the receiving device, the initial metadata (for example, Metadata 410 (Job_{—}20080701.tif).xml, as illustrated in FIG. 4) required for the receiver to request additional transfer of the document is also transferred along with the document to the receiving device. The transferred initial metadata may be added to the queue 231, an example of which is illustrated in Table 1.

TABLE 1
Metadata queue

| | | | | | Initial size | Expiry | | JobLog | Job |
|---|---|---|---|---|---|---|---|---|---|
| No. | Sender | Receiver | Destination | Created | (bytes) | time | Interval | ID | Type |
| 1 | Tom | David | FTP Server | 2008.06.30, | 1,137 | 60 min. | 30 sec. | 3157 | FTP |
| | | | | 11:16:34 | | | | | |

In Table 1, ‘Created’ indicates the date and time at which initial metadata is transferred to the receiver; ‘Initial size’ indicates the initial file size of the initial metadata; ‘Expiry time’ indicates the expiration time of the initial metadata; ‘Interval’ indicates the polling interval of the initial metadata; ‘JobLog ID’ indicates information to identify the transferred document; and ‘Job Type’ indicates attributes of the destination.

Referring to Table 1, it is illustrated that Tom, a user of the image forming apparatus 200, transferred a document having ID ‘3157’ to an FTP server belonging to David. In this situation, initial metadata required for David to request transfer of the document to another destination was transferred along with the document ‘3157’ to the FTP server belonging to David. The expiration time and polling interval of the initial metadata were set to 60 minutes and 30 seconds, respectively, so the control unit 270 determines whether metadata edited by David is transmitted, while monitoring the FTP server every 30 seconds for 60 minutes, that is from 11:16:34 to 12:16:34. In other words, the control unit 270 determines whether the edited metadata is stored in the FTP server in order for David to request an additional transfer.

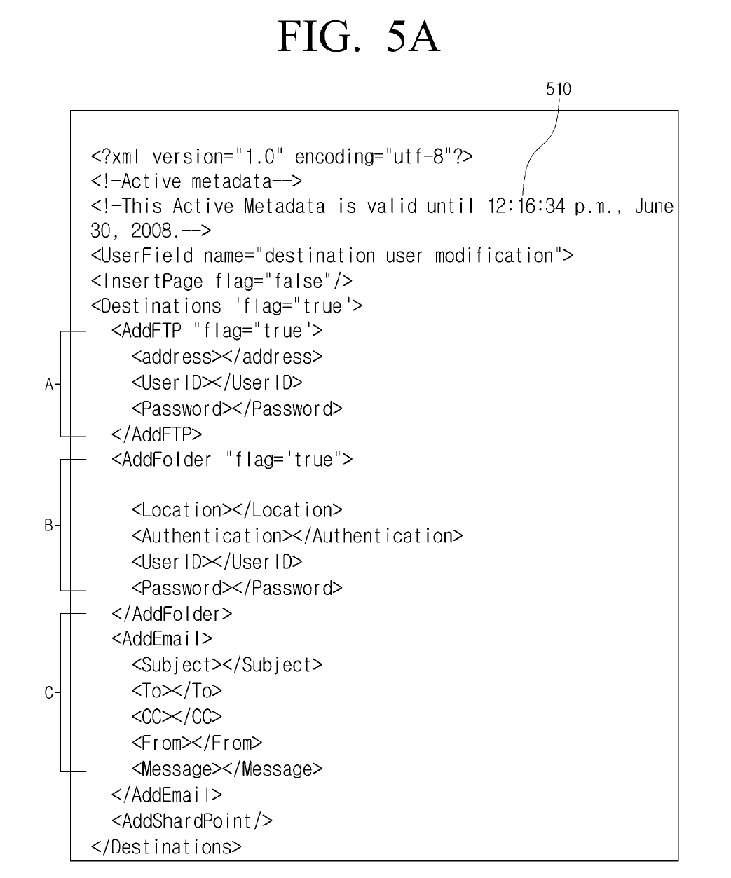

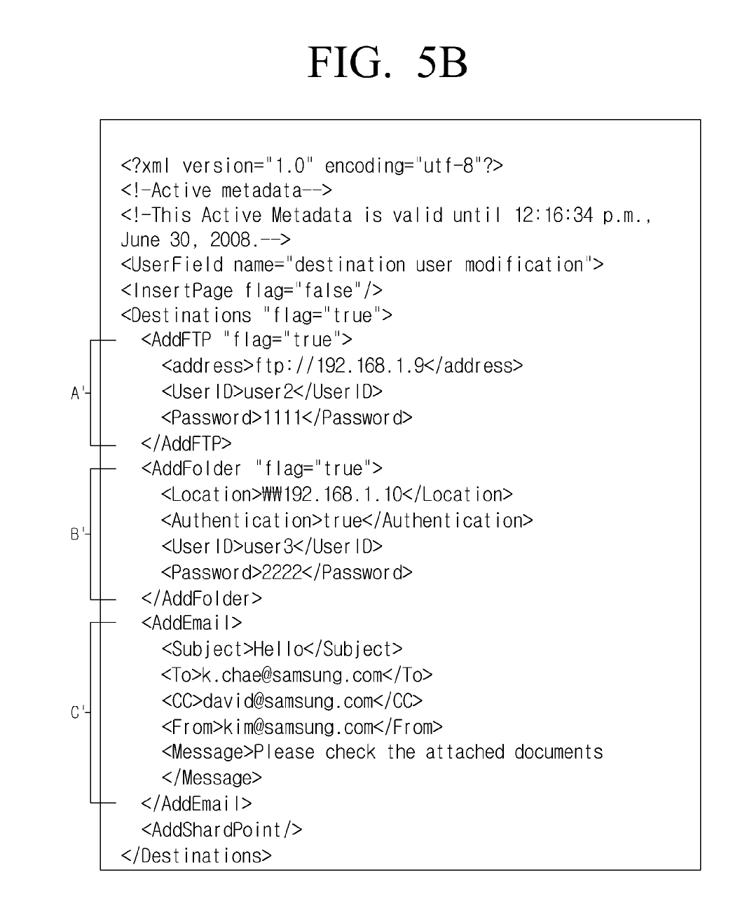

The receiver can check the document stored in the receiving device, and can enter another destination, to which the document is to be transferred, in the initial metadata. For example, if the receiver accesses the receiving device using the user terminal 100 and opens the initial metadata stored in the receiving device, initial metadata written in XML may be displayed on a monitor of the user terminal 100, as illustrated in FIG. 5A. The expiration time 510 of the metadata is entered in the initial metadata, as illustrated in FIG. 5A.

If the receiver desires to additionally transfer the document to the FTP server 2, he or she may input an address of the FTP server 2 and his or her ID and password in field A of FIG. 5A related to an FTP transfer mode. Additionally, if the receiver desires to additionally transfer the document to a public folder, he or she may input an address of the public folder and his or her ID and password in field B of FIG. 5A. Furthermore, if the receiver desires to additionally transfer the document using e-mail, he or she may input the recipient's e-mail address, a subject and a message in field C of FIG. 5A related to an e-mail transfer mode.

If the receiver enters addresses of the FTP server 2, public folder and e-mail, in the fields A, B, and C, respectively, in the initial metadata of FIG. 5A, the initial metadata of FIG. 5A is edited as illustrated in fields A′, B′, and C′ in FIG. 5B. The edited metadata can be stored in the same directory as the initial metadata. The edited metadata can also be stored in another location, provided it is associated with the initial metadata. Accordingly, the receiver may request that the image forming apparatus 200 additionally transfer the document to another destination.

After transferring the document and initial metadata to the receiving device, the control unit 270 determines whether the initial metadata is edited by accessing the receiving device at the set polling interval. According to the control of the control unit 270, the edited metadata, namely the modified metadata, is loaded from the receiving device to the image forming apparatus 200 and added to the queue 231.

The control unit 270 can control the metadata received from the receiving device to be added to the queue 231, as illustrated in Table 2.

TABLE 2
Metadata queue

| | | | | | Modified | | | | |
|---|---|---|---|---|---|---|---|---|---|
| | | | | Modified | size | Expiry | | JobLog | Job |
| No. | Sender | Receiver | Destination | date | (bytes) | time | Interval | ID | Type |
| 1 | Tom | David | FTP | 2008.06.30, | 1,200 | — | — | 3157 | FTP |
| | | | | 11:20:30, | | | | | |
| 2 | Tom | David | FTP | 2008.06.30, | 1,200 | — | — | 3157 | Pub- |
| | | | | 11:20:30 | | | | | lic |
| | | | | | | | | | folder |
| 3 | Tom | David | FTP | 2008.06.30, | 1,200 | — | — | 3157 | E- |
| | | | | 11:20:30 | | | | | mail |

In Table 2, ‘Modified date’ indicates the date and time at which the modified metadata is received from the receiver; ‘Modified size’ indicates the file size of the modified metadata; ‘Expiry time’ indicates the expiration time; ‘Interval’ indicates the polling interval; ‘JobLog ID’ indicates information to identify the transferred document; and ‘Job Type’ indicates attributes of the destination.

The control unit 270 determines whether metadata having a JobLog ID identical to that of the initial metadata is added to the queue 231 while monitoring the queue 231 at the polling interval of the metadata stored in the queue 231.

If it is determined that the metadata having the JobLog ID identical to that of the initial metadata is added to the queue 231, the control unit 270 compares the metadata to the initial metadata, and determines whether there is a change, and if so, the control unit 270 determines that the document ‘3157’ is requested to be additionally transferred. For example, if the date or size of the metadata changes, the control unit 270 may determine that the receiving device requests that the document be additionally transferred.

Referring to Table 2, it is illustrated that initial metadata was modified at 11:20:30, Jun. 30, 2008, and the size of the modified metadata is 1,200 bytes. Additionally, David sent a request to the FTP server that the document be additionally transferred (No. 1). The address of the FTP server and user's ID are entered in the modified metadata, as illustrated in field A′ of FIG. 5B, and may be set to be displayed on the display panel 214.

Accordingly, since the size, date and Job Type of the metadata are modified, the control unit 270 can determine that additional transfer of the document is requested. The control unit 270 converts the document to protocols according to the Job Type such as an FTP (No. 1), public folder (No. 2) or e-mail (No. 3), and controls the communication unit 220 to transfer the document to each address. For example, if the Job Type is FTP, as illustrated in field A′ of FIG. 5B, the communication unit 220 may transfer the document to ‘ftp://192.168.1.9’, namely an address of the FTP server.

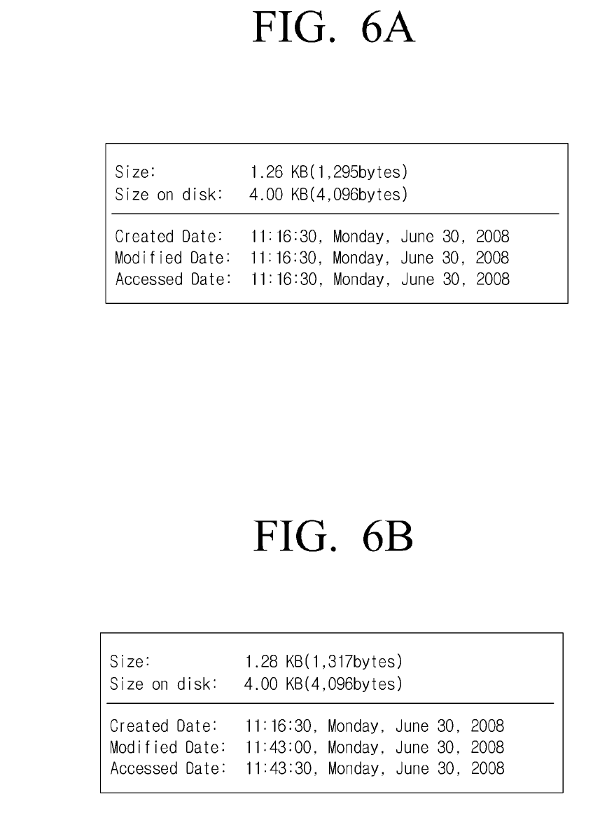

FIG. 6A exemplarily illustrates initial metadata transferred to a receiving device, and FIG. 6B exemplarily illustrates metadata edited by a receiver.

In FIG. 6A, the created date, modified date and accessed date of the initial metadata are identical to each other, so the control unit 270 determines that the metadata has not been updated recently.

In FIG. 6B, the created date of the metadata added to the queue 231 differs from the modified date of the metadata. In more detail, the receiver edited the initial metadata and stored the edited metadata in the receiving device at 11:43:00, Jun. 30, 2008 (the “Modified Date”), and the control unit 270 accessed the metadata at 11:43:30, Jun. 30, 2008 (the “Accessed Date”) to confirm that the modified metadata was stored in the receiving device.

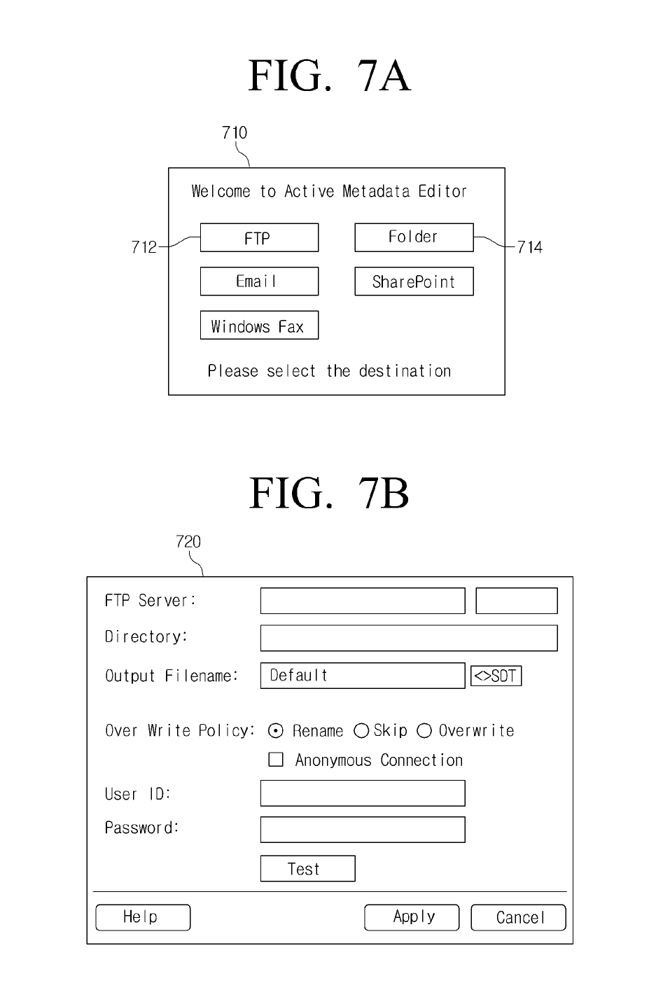

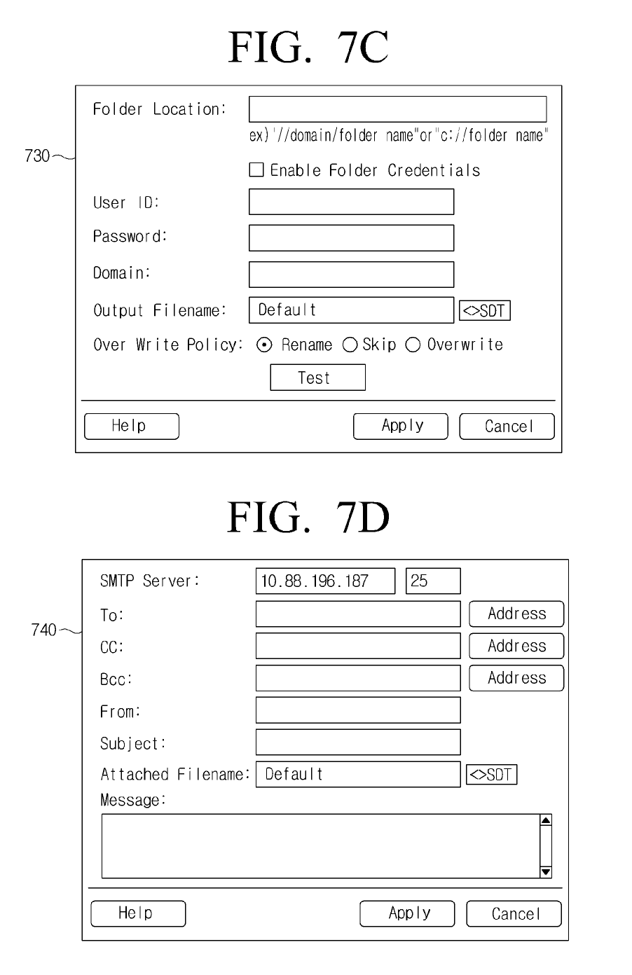

The metadata editing process described with reference to FIGS. 5A and 5B may be implemented using user interfaces (UIs) such as those exemplarily illustrated in FIGS. 7A to 7D. Assuming that the image forming apparatus 200 is used as a sending device and the directory 2a on the FTP server 2 is used as a receiving device, if a sender transfers a document and initial metadata to the directory 2a, the document may be requested to be additionally transferred to another destination or the same destination as follows.

If the receiver logs onto the FTP server 2 using the user terminal 100, the document and initial metadata stored in the directory 2a may be displayed on the monitor of the user terminal 100, as illustrated in FIG. 4. In this situation, if the receiver selects the initial metadata as illustrated in FIG. 4, an initial menu to edit the initial metadata may be displayed on the monitor of the user terminal 100, as illustrated in FIG. 7A.

The UI 710 illustrated in FIG. 7A displays job types corresponding to a plurality of destinations to which a document can be additionally transferred. If a user selects one of the plurality of destinations on the UI 710 of FIG. 7A, the user terminal 100 can display another UI through which a user is able to enter detailed information on the selected destination. For example, if a user selects an FTP 712 through the UI 710 of FIG. 7A, an FTP UI 720 may be displayed on the user terminal 100, as illustrated in FIG. 7B, so that the user may input an address of the FTP server 2, a directory address, and his or her ID and password. The UI 710 may be generated from the user terminal 100 and displayable on a display unit connectable to the user terminal 100. When the user terminal 100 and the display unit are formed in a single body, the user terminal 100 controls the display unit to display the UI 710.

Alternatively, if the user selects a folder 714 through the UI 710 of FIG. 7A, a folder UI 730 may be displayed on the user terminal 100, as illustrated in FIG. 7C, so that the user may input detailed information required to additionally transfer a document to a public folder. FIG. 7D exemplarily illustrates an SMTP UI 740 required to additionally transfer a document by e-mail. The detailed information input by a user can be transmitted from the directory 2a as edited metadata to the sending device (for example, the image forming apparatus 200).

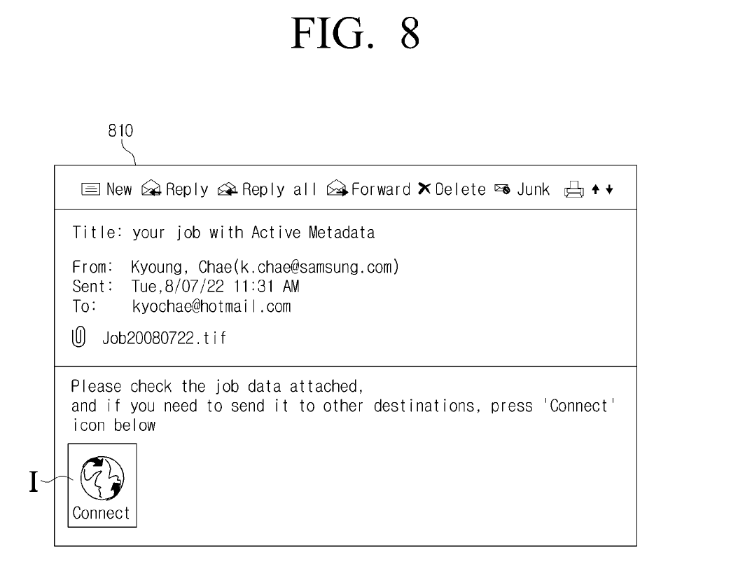

FIG. 8 exemplarily illustrates initial metadata provided to a receiver when the receiving device is the SMTP server 3.

Referring to FIG. 8, if a user of the image forming apparatus 200 e-mails a document and initial metadata to the SMTP server 3, the document and initial metadata are transmitted to the SMTP server 3. If the user logs onto the SMTP server 3 using the user terminal 100, a UI 810 may be displayed on the user terminal 100 as illustrated in FIG. 8 to show an e-mail message, and the initial metadata may be displayed as an icon 1.

If the user desires to request the image forming apparatus 200 to additionally transfer the document or e-mail message, he or she may click on the icon I, so the metadata illustrated in FIG. 5A or the UI 710 illustrated in FIG. 7A may appear on the user terminal 100. Various UIs may be provided to the receiver according to the transfer mode, such as FTP, public folder or e-mail, as illustrated in FIGS. 5A, 7A and 8, so the initial metadata may be provided according to the situation. Therefore, it is possible to increase user convenience.

As described above, if the image forming apparatus 200 includes the queue 231 to store metadata, and functions as a sending device, it is possible for the receiver to request that the document received from the image forming apparatus 200 be automatically transferred to another destination. In more detail, the receiver can enter a destination in the initial metadata stored in the receiving device and can edit the initial metadata, so the image forming apparatus 200 may additionally transfer the document to the destination entered in the edited metadata.

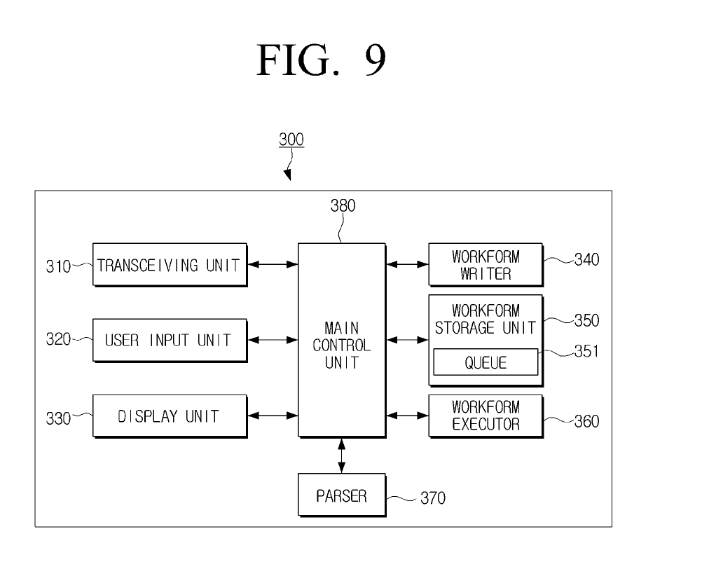

FIG. 9 illustrates a block diagram of a document management apparatus 300 used as a document transfer apparatus according to an exemplary embodiment of the present general inventive concept.

In FIG. 9, the document management apparatus 300, which can function as a document transfer apparatus, namely a sending device, includes a transceiving unit 310, a user input unit 320, a display unit 330, a workform writer 340, a workform storage unit 350, a workform executor 360, a parser 370 and a main control unit 380.

The transceiving unit 310 can be communicably connected to the user terminal 100 and the image forming apparatus 200 through a wired or wireless communication network (not illustrated). The transceiving unit 310 can receive user authentication information or a workform transfer request command from the user terminal 100 or the image forming apparatus 200, and can transmit a workform to the image forming apparatus 200.

If the image forming apparatus 200 functions as a receiving device, the transceiving unit 310 can transmit a document and initial metadata to the image forming apparatus 200 according to a user selection. The receiving device may include, for example, the user terminal 100, the image forming apparatus 200, the file server 1, the FTP server 2 or the SMTP server 3.

The user input unit 320 can be a UI such as a keyboard or mouse. The user input unit 320 outputs a signal to select and request functions supported by the document management apparatus 300. When a user desires to manually make a workform using the document management apparatus 300, he or she may enter a request command to implement a solution related to writing of workforms using the user input unit 320, so that a workform screen provided by the workform writer 340 may be displayed by the display unit 330. Alternatively, if the user manually writes a workform using the user terminal 100, a workform screen may be displayed on the user terminal 100.

The workform writer 340 can write or edit workforms in response to a user command by implementing a workform management solution. The written workforms can be transmitted to the user terminal 100 which the user logs onto or to image forming apparatus 200, and can be stored or displayed on the user terminal 100 or the image forming apparatus 200.

If the user selects a workform, the workform writer 340 can generate menus as illustrated in FIGS. 3C and 3D, and can display the generated menus on the display unit 330. The menus of FIGS. 3C and 3D have been described above, so further description will be omitted. Additionally, initial metadata having an expiration time and polling interval set through the menu of FIG. 3D may be added to a queue 351, and may be transferred along with a document to the receiving device.

The workform storage unit 350 can store various programs required to operate the document management apparatus 300, an operating system (OS), a workform management solution, a program to drive the workform management solution, and various types of data generated when the operation of the document management apparatus 300 is performed. Additionally, the workform storage unit 350 can store user authentication information, workforms written for each user, data required to write workforms, or documents transferred to each receiving device.

The workform storage unit 350 can include the queue 351 to store initial metadata selected by a user. If the receiver edits initial metadata, the edited metadata may be updated to the queue 351.

The workform executor 360 can transfer a document and initial metadata corresponding to the workform selected by the user. In more detail, the workform executor 360 may convert a document format into a transferable format using, for example, protocols respectively supported by the file server 1, FTP server 2, SMTP server 3 and image forming apparatus 200 which are capable of receiving the document. For example, if the SMTP server 3 is a destination, the workform executor 360 may convert a document format into a transferable format using an SMTP supported by the SMTP server 3.

The parser 370 can parse the edited metadata which the transceiving unit 310 loads from the receiving device. The parsed metadata can be added to the queue 351.

The main control unit 380 can control the overall operation of the document management apparatus 300 using various programs stored in the workform storage unit 350. The main control unit 380 can launch a workform management solution, and can control the transceiving unit 310 so that the document management apparatus 300 transmits the workforms to the user terminal 100 or image forming apparatus 200, when prewritten workforms change or when user requests are received.

The main control unit 380 can control the transceiving unit 310 to transfer the document and initial metadata to the receiving device, so that the transferred metadata is added to the queue 351. Additionally, the main control unit 380 can determine whether the edited metadata is stored in the receiving device by accessing the receiving device at the set polling interval.

In more detail, the main control unit 380 can access the receiving device and can compare the initial metadata stored in the receiving device to other metadata. If the recent modified date and the size of the initial metadata differ, the main control unit 380 can determine that the edited metadata is stored in the receiving device, and can determine that a document is requested to be additionally transferred. Additionally, the main control unit 380 can load the edited metadata, can add the loaded metadata to the queue 351, and can check information to identify the document and the destination to which the document is to be sent, for example, a JobLog ID and Job Type of the edited metadata. The main control unit 380 can read out a document having a JobLog ID from the workform storage unit 350, and can control the transceiving unit 310 so that the read document is additionally transferred to a destination corresponding to the Job Type.

Hereinafter, a situation in which the image forming apparatus 200 functions as a sending device will be described to explain a method by which a receiving device requests additional transfer of a document.

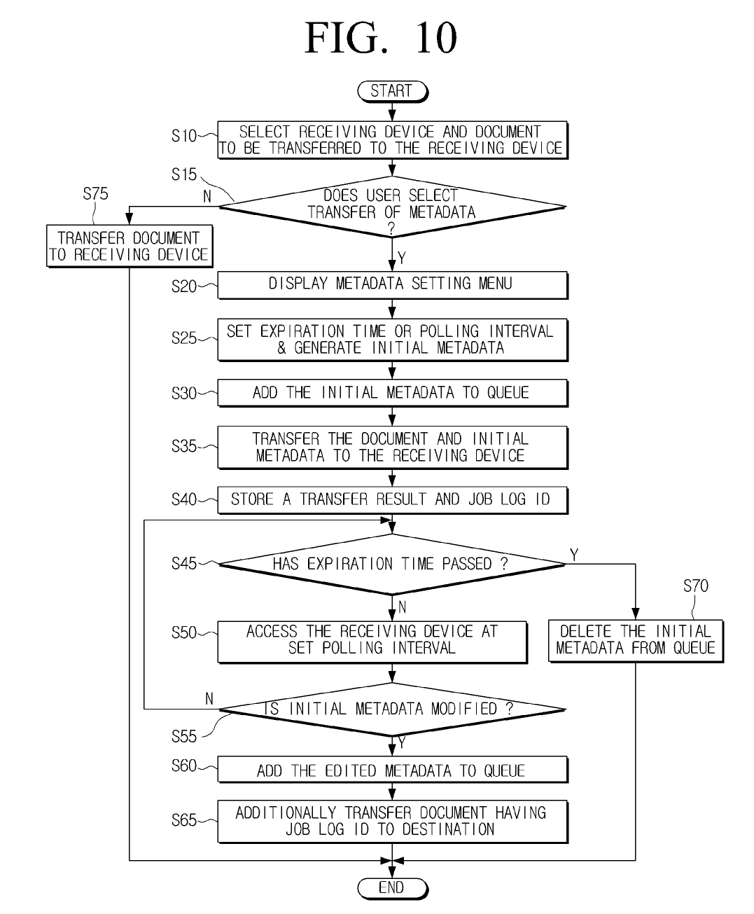

FIG. 10 is a flowchart illustrating a document transfer method according to an exemplary embodiment of the present general inventive concept.

Referring to FIGS. 1 to 8 and 10, if an apparatus, for example, the image forming apparatus 200, is used as a sending device, the user selects a receiving device and a document to be transferred to the receiving device using the image forming apparatus 200 in operation S10, and the image forming apparatus 200 displays a message asking whether to transfer metadata, as illustrated in FIG. 3C, on the display panel 214c. Subsequently, if the user selects ‘Settings’ 340 in the display 214c from the displayed message in operation S15, a metadata setting menu as illustrated in FIG. 3D is displayed on the display panel 214d in operation S20. The sending device may be, for example, image forming apparatus 200, document management apparatus 300, file server 1, FTP server 2, or SMTP server 3.

If the user sets an expiration time or a polling interval of metadata using the user input unit 212 and generates initial metadata in operation S25, the control unit 270 adds the generated initial metadata to the queue 231 in operation S30. During operation S15, if the user selects ‘Yes’ 345 in the display 214c on the displayed message, the control unit 270 adds preset initial metadata stored in the storage unit 230 to the queue 231.

The control unit 270 controls the communication unit 220 to transfer the document and initial metadata to the receiving device in operation S35, and stores a transfer result and a JobLog ID of the transferred document in the storage unit 230 in operation S40. The stored JobLog ID may be used to additionally transfer the document.

The control unit 270 can access the receiving device at the set polling interval until the expiration time set in operation S20 passes, and can determine whether the initial metadata is modified in operations S45, S50 and S55. If it is determined that the initial metadata is modified, that is, if metadata edited by entering a destination to which the document is to be additionally transferred is stored in the receiving device, the control unit 270 controls the communication unit 220 to load the edited metadata from the receiving device, and adds the loaded metadata to the queue 231 in operation S60. Accordingly, the metadata can be added to the queue 231, as illustrated in Table 2.

The control unit 270 then can control the communication unit 220 to transfer the edited metadata added to the queue 231 to the destination to which the document is to be additionally transferred in operation S65. Specifically, the control unit 270 can check the JobLog ID and Job Type of the metadata added to the queue 231, and can read out a document corresponding to the JobLog ID from the storage unit 230. The control unit 270 can control the communication unit 220 to convert the read document using a protocol corresponding to the Job Type and transfer the converted document to the destination. In this situation, a user of the image forming apparatus 200 may add the initial metadata to the document to be additionally transferred.

If the expiration time passes in operation S45, the control unit 270 deletes the initial metadata from the queue 231 in operation S70. In this case, the image forming apparatus 200 does not transfer the document even when the receiving device requests additional transfer of the document after the expiration time.

Additionally, if the user does not wish to transfer metadata in operation S15, the control unit 270 controls the communication unit 220 to transfer the document selected in operation S10 to the receiving device in operation S75.

The document transfer method described with reference to FIG. 10 may also be applied to a situation in which the document management apparatus 300 functions as a sending device. Additionally, the document transfer method described above may also be applied to a situation in which general documents are transferred to the receiving device.

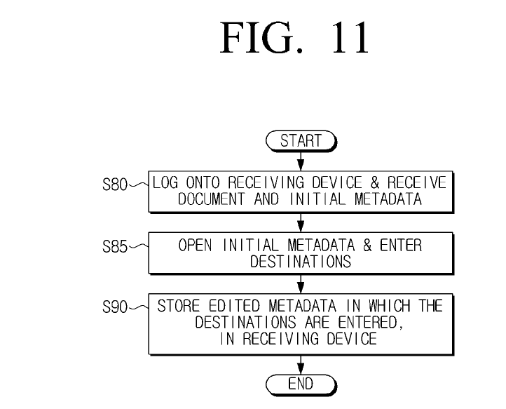

FIG. 11 is a flowchart illustrating a method by which a receiving device requests additional transfer of a document according to an exemplary embodiment of the present general inventive concept.

In FIG. 11, a user logs onto the receiving device using the user terminal 100, and receives a document and initial metadata in operation S80. The receiving device may be any device capable of receiving a document, for example, the user terminal 100, image forming apparatus 200, document management apparatus 300, file server 1, FTP server 2 or SMTP server 3.

If the user opens the initial metadata, a menu as illustrated in FIG. 5A or FIG. 7A may be displayed on the user terminal 100. The user may write or select one or more destinations to which the document is to be additionally transferred, using the displayed menu in operation S85.

Metadata edited by entering the destinations can be stored in a directory of the receiver in operation S90. Accordingly, a sending device, for example, the image forming apparatus 200 can access the receiving device at the set polling interval and determines whether the initial metadata is modified in operation S50.

As described above, the receiver may easily request additional transfer of a required document using the metadata. Additionally, the present general inventive concept is also applicable to a situation in which a secret document is received from a sending device, and only a sender transfers the secret document.

Furthermore, according to the present general inventive concept, a sending device may be one of at least one image forming apparatus and a server to manage a document, and a receiving device and destination may be one of an image forming apparatus, an SMTP server, an FTP server, a public folder and a personal terminal. The personal terminal refers to a personal digital device capable of receiving a document, for example, a computer, a mobile phone or a PDA.

The present general inventive concept can also be embodied as computer-readable codes on a computer-readable medium. The computer-readable medium can include a computer-readable recording medium and a computer-readable transmission medium. The computer-readable recording medium is any data storage device that can store data which an be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in distributed fashion. The computer-readable transmission medium can transmit carrier waves and signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A document transfer method comprising:
transferring a document and metadata required to manage the document from a sending device to a receiving device;
editing the transferred metadata;
storing the edited metadata; and
additionally transferring the document from the sending device based on the stored metadata.

2. The document transfer method of claim 1, wherein the editing of the transferred metadata comprises:
displaying the transferred metadata; and
adding at least one destination and at least one transfer mode to the displayed metadata, to edit the metadata.

3. The document transfer method of claim 1, further comprising:
determining whether the transferred metadata is edited; and
adding the edited metadata to a queue of the sending device if it is determined that the transferred metadata is edited.

4. The document transfer method of claim 3, wherein the additionally transferring of the document comprises:
checking a destination entered by a user of the receiving device from the edited metadata added to the queue; and
additionally transferring the document to the checked destination.

5. The document transfer method of claim 1, wherein the metadata transferred to the receiving device comprises an expiration time prior to which the document can be additionally transferred.

6. The document transfer method of claim 1, further comprising:
accessing the receiving device at a regular interval set for the transferred metadata and determining whether the edited metadata is stored.

7. The document transfer method of claim 1, further comprising:
displaying a result of whether or not the document was additionally transferred on at least one of the sending device and the receiving device.

8. The document transfer method of claim 1, wherein:
the sending device is one of at least one image forming apparatus and a server to manage the document; and
the receiving device and the destination are at least one of an image forming apparatus, a simple mail transfer protocol (SMTP) server, a file transfer protocol (FTP) server, a public folder and a personal terminal to receive the document.

9. A document transfer apparatus comprising:
a storage unit to store metadata required to manage a document;
a communication unit to transfer the document and the stored metadata to a receiving device, and to poll the transferred metadata to determine if the transferred metadata is edited; and
a control unit to control the communication unit to additionally transfer the document based on the edited metadata.

10. The document transfer apparatus of claim 9, wherein a user of the receiving device adds at least one destination and at least one transfer mode to the transferred metadata, to edit the transferred metadata.

11. The document transfer apparatus of claim 9, wherein if it is determined that the transferred metadata is edited, the control unit loads the edited metadata stored in the receiving device and adds the loaded metadata to a queue.

12. The document transfer apparatus of claim 11, wherein the control unit checks a destination entered by the user of the receiving device from the edited metadata added to the queue, and controls the communication unit to additionally transfer the document to the checked destination.

13. The document transfer apparatus of claim 9, further comprising:
a display unit to display a menu to select a transfer of the metadata; and
a user input unit to select a transfer of the metadata through the displayed menu, and to set an expiration time prior to which the document can be additionally transferred,
wherein the control unit accesses the receiving device before the set expiration time.

14. The document transfer apparatus of claim 13, wherein the metadata transferred to the receiving device comprises the set expiration time.

15. The document transfer apparatus of claim 9, further comprising:
a display unit to display a menu to select a transfer of the metadata; and
a user input unit to select a transfer of the metadata through the displayed menu, and to set a polling interval to access the receiving device through the displayed menu,
wherein the control unit accesses the receiving device at the set polling interval to determine whether the metadata is edited.

16. The document transfer apparatus of claim 9, wherein:
the sending device is one of at least one image forming apparatus and a server to manage the document; and
the receiving device and the destination are at least one of an image forming apparatus, a simple mail transfer protocol (SMTP) server, a file transfer protocol (FTP) server, a public folder and a personal terminal to receive the document.

17. The document transfer apparatus of claim 9, wherein a result of whether or not the document was additionally transferred is displayed on at least one of the sending device and the receiving device.

18. A document transfer system comprising:
a sending device to transfer a document and metadata required to request an additional transfer of the document; and
at least one receiving device to receive the document and the metadata and to store the metadata edited to additionally transfer the document,
wherein the sending device additionally transfers the document based on the edited metadata.

19. The document transfer system of claim 18, further comprising:
a user terminal to access the receiving device, display the transferred metadata, enter at least one destination in the displayed metadata, edit the metadata, and control the edited metadata to be stored in the receiving device.

20. A method of transferring a document in a receiving device, the method comprising:
receiving a document and metadata associated with the document from a sending device; and
editing the metadata and transmitting the edited metadata to the sending device to request the sending device to transfer the document to a second receiving device according to the edited metadata,
wherein the editing is performed at a receiving device which receives the document and the metadata.

21. The method of claim 20, wherein the metadata includes at least one of a destination for the second receiving device, an expiration time and a polling interval.

22. The method of claim 20, further comprising:
if the metadata is edited, transferring the edited metadata to the sending device and transferring the document to the second receiving device according to the edited metadata.
